(19) United States
(12) Patent Application Publication
(10) Pub. No.: US 2025/0251722 A1
(43) Pub. Date: Aug. 7, 2025

(54) SYSTEMS AND METHODS FOR REMOTE MACHINE AND EQUIPMENT MONITORING USING COMPRESSED SENSING TECHNIQUES

(71) Applicant: THE PENN STATE RESEARCH FOUNDATION, University Park, PA (US)

(72) Inventors: Ankur VERMA, University Park, PA (US); Soundar R. TIRUPATIKUMARA, University Park, PA (US)

(21) Appl. No.: 18/856,601

(22) PCT Filed: Apr. 13, 2023
(86) PCT No.: PCT/US2023/018553

§ 371 Date: Oct. 11, 2024

Related U.S. Application Data
(60) Provisional application No. 63/330,669, filed on Apr. 13, 2022.

(51) Int. Cl. G05B 23/02

(52) U.S. Cl. CPC G05B 23/0221; G05B 23/024

(57) ABSTRACT

A method for machine monitoring is disclosed. The method includes obtaining a subset of the plurality of first data points from a local sensor connected to a machine; generating a plurality of second data points based on the subset of the plurality of first data points based on a compressed sensing technique; and identifying at least one of an operating fault or a prediction of an operating fault, based on the plurality of second data and communicating the same to an operator of the machine. Further, the method may exploit machine learning based on the low-dimensional representation learned using undersampled data. The amount of undersampling can be governed by the information content in the signal. Other aspects, embodiments, and features are also claimed and described.

### CROSS-REFERENCE TO RELATED APPLICATION

This application claims the benefit of U.S. Provisional Patent Application Ser. No. 63/330,669, filed Apr. 13, 2022, the disclosure of which is hereby incorporated by reference in its entirety, including all figures, tables, and drawings.

### STATEMENT REGARDING FEDERALLY SPONSORED RESEARCH

N/A

### TECHNICAL FIELD

The technology discussed herein relates generally to sensor data acquisition and analysis. More specifically, in some embodiments the techniques described herein may be utilized for efficient, remote sensing of industrial machines and other machines and sources of similar data.

### BACKGROUND

Sensor-based ‘big data’ applications offer unprecedented opportunities for real-time information extraction in manufacturing and other fields. However, known techniques are inefficient and uneconomical to operate, given the volume of data that is generated and collected and the difficult and high degree of resources needed to transmit, store, and process that data. What are needed are systems and methods that address one or more of these shortcomings.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, a method, a system, and/or an apparatus for machine monitoring is disclosed. The method, the system implementing the method, and/or the apparatus implementing the method may include obtaining a subset of the plurality of first data points from a local sensor connected to a machine. The local sensor directly senses operating conditions of the machine to generate the plurality of first data points, the subset of the plurality of first data points representing an undersampling of output of the sensor. The method, the system implementing the method, and/or the apparatus implementing the method may further include generating a plurality of second data points based on the subset of the plurality of first data points based on a compressed sensing technique. The plurality of second data points is less than the plurality of first data points. The method, the system implementing the method, and/or the apparatus implementing the method may further include identifying at least one of an operating fault or a prediction of an operating fault, based on the plurality of second data and communicating the same to an operator of the machine.

In another example, a method, a system, and/or an apparatus for machine monitoring is disclosed. The method, the system implementing the method, and/or the apparatus implementing the method may include receiving, from a device, a plurality of first data points from a local sensor connected to a machine The local sensor directly senses operating conditions of the machine to generate the plurality of first data points. The method, the system implementing the method, and/or the apparatus implementing the method may also include sampling in real-time, from the device, a subset of the plurality of first data points. The subset of the plurality of first data points represents an undersampling of the plurality of first data points of the sensor. The method, the system implementing the method, and/or the apparatus implementing the method may also include transmitting, from the device, the subset to a cloud with indices corresponding to the subset; receiving in real-time, from a server, the subset of the plurality of first data points; generating in real-time, from the server, a plurality of second data points based on the subset of the plurality of first data points based on a compressed sensing technique; and identifying in real-time, from the server, at least one of an operating fault or a prediction of an operating fault, based on the plurality of second data and communicating the same to an operator of the machine. The plurality of second data points is less than the plurality of first data points.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is an illustration of an example of compressed sensing based data acquisition and analysis framework according to some embodiments.

FIG. 2 is an illustration of an example of data acquisition and analysis techniques according to some embodiments.

FIG. 3 is an illustration of an example of algorithmic flowchart according to some embodiments.

FIG. 4 is an illustration of an exemplary architecture of methodology of high-dimensional signal followed by undersampling, compressed sensing-based reconstruction, and usage of low-dimensional embeddings for problem-solving according to some embodiments according to some embodiments.

FIG. 5A is an exemplary graph showing original FFT for acoustic calibration, and FIG. 5B is an exemplary graph showing CS recovered FFT for acoustic calibration (10% samples, s=5) according to some embodiments.

FIG. 6A is another exemplary graph showing original FFT for machinery fault simulator, and FIG. 6B is an exemplary graph showing CS recovered FFT for machinery fault simulator (10% samples, s=5) according to some embodiments.

FIG. 7A is another exemplary graph showing original FFT for universal joint setup, and FIG. 7B is an exemplary graph showing CS recovered FFT for universal joint setup (10% samples, s=5) according to some embodiments.

FIG. 8A is an exemplary graph showing a variation of test score of machine learning algorithms with sampling (10 averages, 25 Hz), and FIG. 8B is an exemplary graph showing a variation of test score of machine learning algorithms with sampling (10 averages, 17 Hz) according to some embodiments.

FIG. 9 is a flow chart illustrating an exemplary process for machine monitoring according to some aspects of the disclosure.

FIG. 10 is a block diagram conceptually illustrating an example of a hardware implementation for the methods disclosed herein.

FIG. 11 is another block diagram conceptually illustrating an example of a hardware implementation for the methods disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### 1. Summary

The present disclosure provides a compressed sensing technique to efficiently monitor and analyze such things as industrial processes, the operation and health of machines, and similar data generation sources, albeit using far less than the full amount of sensor data that is being generated by these machines/processes and the sensors that detect characteristics of their operation. Compressed Sensing (CS) is a set of data acquisition and analysis techniques that facilitate this efficient data transmission and analysis for various types of sensor signals and other data streams. For example, the underlying structure of incoming sensor data regarding operation of an industrial machine can be exploited to collect highly undersampled measurements, which can significantly lower the complexity of Industrial Internet of Things (IIoT) systems and provide significant advantages to efficiency (e.g., reduced downtime, more optimized maintenance schedules, etc.) and cost effectiveness of a process. The present disclosure provides a CS-based framework for data acquisition and analysis and summarizes its performance on exemplary use cases involving temporal sensor signals. These signals exhibit a structure that allows for CS-based recovery. Undersampling will offer cost savings in terms of data transmission (communication), computation, and storage. The present disclosure also quantifies the engineering advantages of measuring less, in terms of data volume, bandwidth, and cost savings. The proposed CS framework contributes to enhancing edge-cloud analytics and decision-making in manufacturing. In addition, the present disclosure introduces undersampling and CS-based recovery as a novel mechanism to transition from ‘big data’ to ‘smart data’ for the Industrial Internet of Things.

### 2. Introduction

Increased machine and process visibility enables better decision making, leading to higher machine uptime, increased throughput, and improved efficiency. From a machine visibility point of view, vibration, sound, and acoustic emissions signals are among the most common sensing modalities which capture the ‘fault signatures’ of different components in various machines. However, vibration and sound-based anomaly detection requires high-frequency data of the order of ˜10 KHz. For instance, a COTS sound sensor samples at 44 KHz. Compounding this with the variety and volume of sensors in industrial environments, both machine and process related data deluge becomes evident.

From a data acquisition and analysis point of view, two criteria that are usually taken into account are: 1—What type of data should be acquired in order to be able to discern the desired insight (which raw data or features (signatures))?; and 2—Can the desired insight be obtained without transmitting and storing all of the original/full/high-fidelity data? The present disclosure offers a solution for both of these sometimes-competing concepts, by allowing for the ability to obtain the same insight from a lesser amount of data.

The present disclosure describes techniques and implementations that make it possible to get the same insight using much lesser data for things such as operating fault detection or prediction, as well as other examples. (Though it is to be understood that the type and needed amount of data may vary from application to application.) In some embodiments, an existing off the shelf sensor may acquire its regular amount (100%) of data, but a system employing the techniques here may cause it to only transmit or store a fraction of that data; in other embodiments, a system may be configured so as to cause a sensor to acquire much less data (random samples) in the first place; these techniques are unlike traditional compression which discards most of the raw data post high-fidelity sampling. The present disclosure proposes a Compressed Sensing (CS) based framework and, for purposes of illustration, evaluates it on three temporal-signals pertinent to manufacturing. The present disclosure discusses the proposed framework for information recovery using much less data than that is required per the Shannon-Nyquist sampling theorem. The present disclosure also details corresponding engineering implications. The present disclosure (i) proposes a CS-based framework for time-signal use-cases, (ii) validates of the proposed framework using three real-world examples, (iii) summarizes the framework's information extraction ability and its engineering implications.

Edge computing comprises enabling technologies allowing computation to be performed at the edge of a network. It enables lesser latency, higher battery life, bandwidth cost savings, and data safety and privacy. On the other hand, cloud computing refers to a computing paradigm where computing is offloaded to a remote, more powerful computer. In many scenarios, edge-cloud collaborative decision making can be exploited in manufacturing. An understanding of edge-cloud computing can be used to evaluate the applicability for different use-cases. Some analytics can be used at the edge, whereas some can be done on the cloud.

Compressed sensing (CS) is a technique that leverages sparse structures in underlying signals, to recover high-resolution signals from highly under sampled measurements. Precise under sampling theorems can be utilized for sparse approximation questions, when they can be modelled exactly through convex polytopes. CS is based on a general linear measurement scheme coupled with an optimization to acquire certain kinds of signals at sub-Nyquist rates. In some examples, sparse recovery algorithms can be used for classifying them into convex relaxation, non-convex optimization, and greedy algorithms. In further examples, the two restrictions of traditional compressed sensing, assumption of sparsity, and long reconstruction times can be alleviated. Deep learning can be combined with compressed sensing to achieve the improvements. CS using generative models can also be used, wherein a pre-trained deep neural network is used as the structural constraint in place of sparsity. A framework to improve both, performance, and speed of recovery can be used by training a generator and the optimization process for reconstruction via meta-learning. Generative Adversarial Nets (GANs) can be considered a special case in the family of above models. From an application point of view, CS is used in a variety of areas including imaging, medical imaging, radar, communications, acoustics, among others. In some scenarios, random under-sampled experiments and compressed sensing can be used in biology, with an article showing improvements in efficiency for spatial imaging of tissues. In further scenarios, CS can be used as a dimensionality reduction tool for anomaly detection (inference) in rotating machinery. In even further scenarios, CS may be used for monitoring temperature in additive manufacturing. CS is a technique that fits well within the monitoring/analytics framework, especially for natural signals and use-cases where the velocity and volume of data are important factors in designing such systems.

Using the notation of CS, the following can be described with respect to the signals considered in this work. x is the fully sampled time-signal having n measurements, C is a random measurement matrix (Gaussian here), and y represents the measurements (randomly sampled signal). Ψ is a transform basis (Discrete Cosine Transform here) and s denotes a sparse vector. y=Cx; y=CΨs; ŝ=argmin ∥s∥₁ subject to y=CΨs, where ∥⋅∥₁ is the L1 norm, given by, ∥s∥₁=Σₖ₌₁ⁿ|sₖ|. For solving the convex optimization problem, a greedy algorithm called Compressed Sensing Matching Pursuit (CoSaMP) can be used. CoSaMP is computationally efficient, open source, and easy to implement.

Industrial asset visibility is the first step towards smart manufacturing. The economic opportunities of using advanced technologies for manufacturing machinery maintenance are important, and CS can allow for a variety of additional smart functions to be effectively and efficiently performed. The multitude of sensors and data in both machine and process monitoring is directed towards enhancing and hastening value-added decision making. Within machine monitoring, sensor signals including vibration, sound, acoustic emission among others capture the ‘signatures’ of underlying machinery. These signatures carry information about a machine's operating condition. Different faults like shaft unbalance, misalignment, looseness, etc. show up in these signals, when transformed into an appropriate basis. For machine monitoring, the Fourier domain is an appropriate basis which facilitates this analysis. Table 1. lists an example of vibration-based fault identification characteristics for the faults and predominant frequencies relevant to a test of this work by the inventors.

TABLE 1
Vibration-based fault identification characteristics

| Fault type | Predominant frequency |
|---|---|
| Shaft unbalance | 1x shaft rotation speed |
| Misalignment | 2x shaft rotation speed |
| Resonance | System's resonant frequency |

Discrete Fourier Transform (DFT) and Discrete Cosine Transform (DCT) are two discretized implementations of the Fourier Transform. The DFT can mathematically be defined as:

$$F [ k ] J = {\sum }_{n = 0}^{N - 1} {x}_{n} {e}^{- 2 π i \frac{nk}{N}} ,$$

for k=0:N−1. The DCT can mathematically be defined as:

$$F [ k ] = {\sum }_{n = 0}^{N - 1} {x}_{n} cos ( \frac{π k ( 2 n + 1 )}{2 N} ) ,$$

for k=0:N−1. Inverse DCT (IDCT) and Inverse FFT (IFFT) are used to reconstruct the time signal from the transformed domain. The IDFT is mathematically defined as:

$${x}_{n} = {\sum }_{n = 0}^{N - 1} F [ k ] {e}^{2 π i \frac{n k}{N}} ,$$

for k=0:N−1. The IDCT is mathematically defined as:

$${x}_{n} = {\sum }_{n = 0}^{N - 1} F [ k ] cos ( \frac{π k ( 2 n + 1 )}{2 N} ) ,$$

for k=0:N−1. This disclosure shows processing 1-D time signals. However, FFT and DCT implementations readily extend to 2-D signals like images, or higher dimensional signals.

In some examples, machine learning methods sample entire incoming high-fidelity data and use the raw data for feature extraction. During feature extraction, most of the high-fidelity data is in a way, discarded. CS can offer a way to learn these features directly from undersampled data, thus negating the need for a high-fidelity sampling and subsequent discarding. There is increased use of data-driven techniques for industrial machine monitoring. Random Forests, Artificial Neural Networks, Support Vector Machines, and k-means clustering can be used in Predictive Maintenance (PdM). These various ML techniques can be used for different machines. However, some challenges, including getting required data, the need for better data analysis techniques, and data security concerns, may exist. These efforts are based on using raw sensor data or extracted features for training the ML models.

### 3. First Exemplary Framework

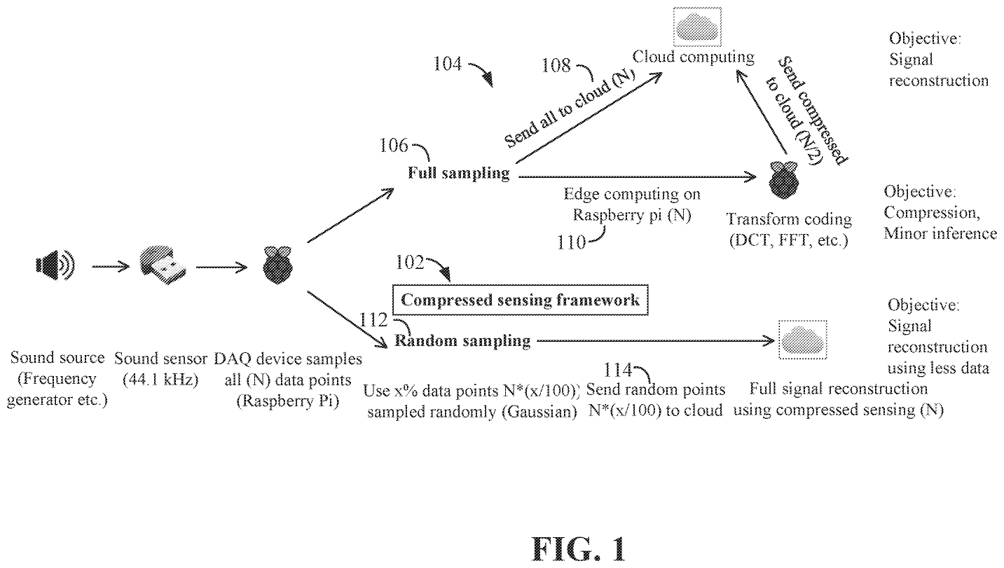

The present disclosure provides examples for a CS-based framework for data acquisition and analysis for time signals pertinent to manufacturing. The framework is generic, and can be extended to other types of signals like imaging, etc. FIG. 1 shows a first exemplary CS-based framework 102 alongside a second exemplary data acquisition and analysis framework 104.

The second exemplary framework 104 involves full sampling 106 at the edge device and then, (i) sending all the data to cloud 108, or (ii) performing edge-computing and sending features or a transformation of the data (FFT etc.) to the cloud 110. In (ii), the amount of data sent to the cloud is significantly reduced without a loss of information. However, the second framework still relies on acquiring all the incoming data (e.g., all data from a sensor measuring vibration of a machine, or an optical sensor monitoring a device or scene). Via the CS framework 102, a set percentage of data points can be randomly sampled 112 instead of acquiring all the incoming data. A random number generator with a fixed seed can be used to generate the random indices. Then, the randomly sampled points 114 can be sent to the cloud or remote computer. In some embodiments, fixing the random seed for data sampling at the edge/sensor negates the need to send corresponding indices to the cloud or remote computer. Rather, indices corresponding to random points can be generated on the cloud, which allows the system to avoid utilizing scarce resources at the edge/sensor to process the indices. This further saves the amount of data sent to the cloud or remote computer.

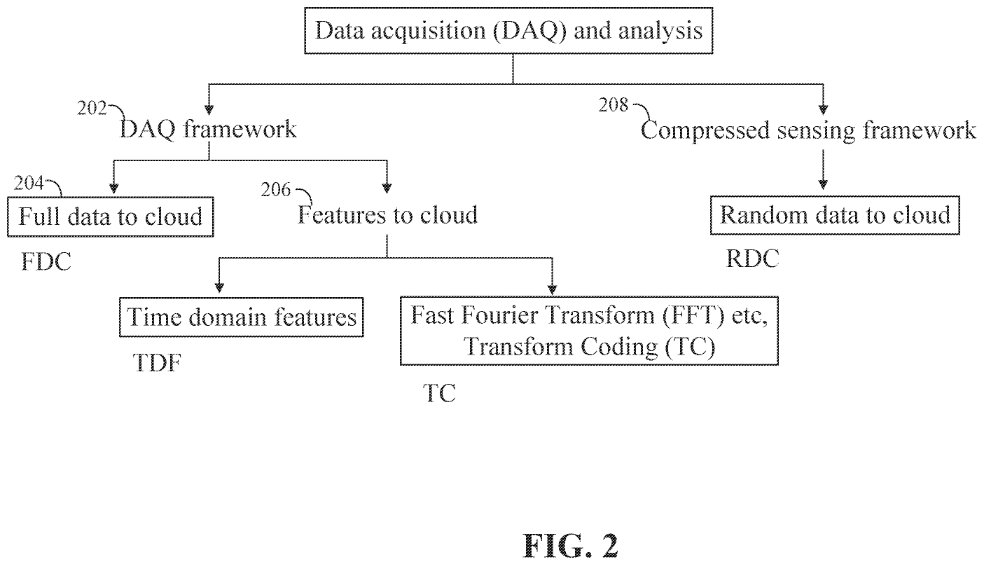

In some examples, 10% of the data points generated by a sensor can be sampled by Gaussian random techniques, and are sufficient for accurate signal reconstruction for the contexts considered. Gaussian random sampling worked best amongst the random sampling schemes tested by the inventors for industrial machine monitoring, which include Uniform and Bernoulli random sampling. A 10× saving can be obtained in comparison to sending all the data to the cloud, and a 5× saving in comparison to sending FFT to the cloud. Where reduced data is sent to the cloud, a reconstruction process is carried out on the cloud or remote computer, where more computational power is available. To investigate the engineering advantages of the CS framework, some abbreviations can be defined in FIG. 2. These abbreviations describe the data/features that are involved in further analysis. While signal reconstruction is an important goal in many monitoring applications, there are other goals like fault detection and classification, which do not require signal reconstruction. These problems can be solved using low-dimensional embeddings learned from undersampled sensor data. The details of this insight and corresponding implementation are described in the exemplary CS framework 102.

In the DAQ framework 202, one technique is to send all the raw data to the cloud 204. This is however not required in the first place, and is very inefficient in terms of latency, costs, energy, and security.

Sending features (FFT transforms, extracted data, etc.) to the cloud 206 is preferable owing to the same level of insight as raw data, but with much less data (50% in case of FFT). There is an opportunity to exploit the structure inherent in many natural signals including the ones covered in this work. CS framework 208 leverages this property to drastically reduce the number of acquired data points. In the CS framework 208, signal reconstruction using 10% Gaussian random points gives the relevant information for the contexts considered. Note that correct amplitude recovery in the reconstructed FFTs, is not guaranteed; however perfectly accurate amplitude recovery may not be required always. For examples pertinent to machine monitoring, shaft unbalance and misalignment are two common faults. They develop over time and comparing relative amplitudes at ‘signature frequencies’ in the FFT will be indicative of fault progression. Moreover, in the example test performed by the inventors the analysis was based on the CoSaMP algorithm; other recovery methods may yield better amplitude recovery. In the contexts considered, accurate frequency information may be used, which is recovered in the CS reconstruction process.

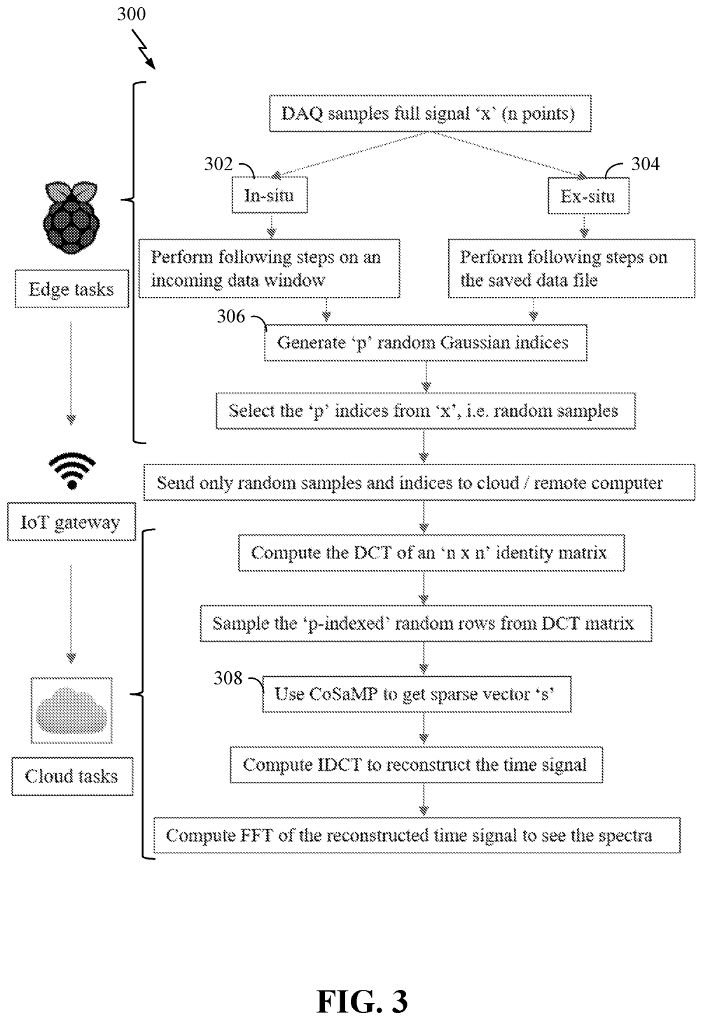

FIG. 3 depicts an example algorithmic flowchart that can be used for data acquisition through signal reconstruction via CS. It differentiates between in-situ 302 and ex-situ 304 random sampling, while mapping steps to where they are executed (edge, IoT, and cloud). In-situ process 302 involves Gaussian randomly sampling 306 the incoming sensor data. Ex-situ process 304 involves randomly sampling 306 from a data file generated during the data acquisition process. Both the processes 302, 304 involve the compressed sensing framework for signal reconstruction using the undersampled data.

In some examples, a Gaussian random sampling scheme may be used with 10% of the time signal sampled randomly. For signal recovery, CoSaMP 308 may be used; a greedy algorithm which performs a convex optimization for minimizing the reconstruction loss. Sparsity level(s) needs to be defined in CoSaMP 308, per the use-case considered. In some scenarios, a fixed random seed can be used on the edge device and cloud to avoid sending the indices to the cloud. This helps preserve the temporal information about the undersampled data, which is used for CS-based recovery.

### 4. Second Exemplary Framework

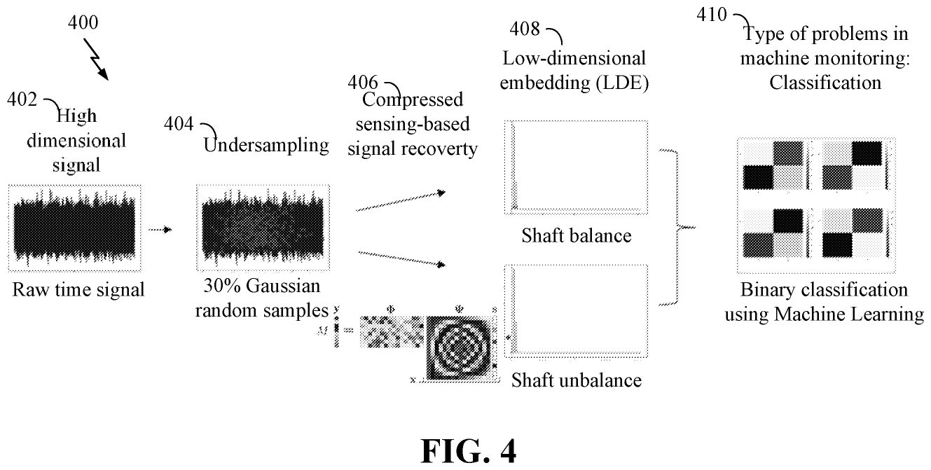

In this example, a new experimental and analysis technique for predictive monitoring of industrial machines is disclosed. The experimental technique involves undersampling whereas the analysis technique involves learning low-dimensional embeddings from undersampled data. This low-dimensional embedding may be the Fast Fourier Transform (FFT). The primary property of low-dimensional embedding (FFT) is to preserve the information while reducing the data dimensionality (memory requirements). In our implementation, the FFT is a parametric basis with a mathematical form and can preserve the information of the signal of interest. Here, FFT is an example of a low-dimensional embedding. Other parametric and non-parametric low-dimensional embeddings can be learned using undersampled data. Because the FFT encodes the full signal in a lower dimension, it can also be used for tasks that require low-dimensional data, such as classification and anomaly detection. The physics of the original high-dimensional signal is preserved by the low-dimensional embedding (FFT), which has been learned from undersampled data. FIG. 4 describes an exemplary architecture 400 of methodology using high-dimensional signal 402 followed by undersampling 404, compressed sensing-based reconstruction 406, and usage of low-dimensional embeddings 408 for problem-solving 410.

In some examples, a Gaussian random sampling scheme can be used, as Gaussian matrices may satisfy the Restricted Isometry and Universality property; two key tenets of the compressed sensing theory. Gaussian random sampling can sample 30% data points from the high-dimensional vibration signal (full signal). The vibration data for a specific rotational speed is sampled for 20 seconds at a sampling rate of 4096 Hz. In some instances, the full signal 402 can be divided into 50 windows 408 of 1600 samples each. Consequently, we have 50-time windows for shaft unbalance (class 0) and 50 time-windows for shaft balance (class 1) 408, resulting in a total of 100 time-windows. These 100 time-windows at a particular rotational speed are one dataset in the examples. Another similar dataset can be generated for a different rotational speed. Hence, two different datasets can be used for two different rotational speeds. Random sampling 404 drastically reduces the amount of data acquired, which has significant implications for bandwidth utilization in data transmission, storage space requirements, and associated costs.

A parametric low-dimensional embedding (FFT) 408 can be generated from random samples 404 using compressed sensing 406. This low-dimensional embedding is a compact way to represent the high-dimensional signal 402 in a transformed basis. Here, compressed sensing can recover the high-dimensional signal 402 from undersampled data 404, by treating this as a sparse approximation problem. One exemplary recovery algorithm is CoSaMP for the signal recovery. 30% random Gaussian samples may be taken from a 1600 data point window of the raw data, and CoSaMP's sparsity level may be kept at 20.

The idea of low-dimensional embeddings 408 extends beyond the parametric bases into non-parametric bases. This can be used in many real-world engineering applications, where parametric bases may not be able to capture the underlying complex dynamics. For example, using techniques like the FFT can capture a variety of faults as signatures in the frequency spectra, but the simultaneous presence of several of these faults may use advanced non-parametric representation techniques. Two generative models: Generative Adversarial Networks (GANs) and Variational Autoencoders (VAEs) may be exploited as non-parametric representations for compressed sensing for imaging applications. Other representation learning techniques like manifold learning can be considered for learning low dimensional embeddings from undersampled data.

In the examples, fault identification 410 can be performed as a classification problem on the low-dimensional embedding of a machine vibration signal. Certain tasks like classification may use low-dimensional embeddings which can be learned directly by using compressed sensing on undersampled data. For these problems, high-dimensional details and thus, the full signal might not be necessary. In the examples, the vibration data consists of a machine fault: shaft unbalance. This fault is evident in the low-dimensional embedding (FFT) as a peak at 1× of the rotational speed, wherein this FFT is reconstructed from undersampled data rather than the high-dimensional signal (full signal). Four machine learning algorithms can be utilized for performance testing on the classification problem: (i) Logistic Regression, (ii) Artificial Neural Networks, (iii) Random Forests, and (iv) Support Vector Machines. These algorithms quantify the information preserving capability of low-dimensional embeddings learned from undersampled sensor data (using compressed sensing) to identify shaft unbalance; a major fault in industrial machinery.

The raw vibration signal is a uni-directional acceleration measurement (m/s2), sampled at 4096 Hz for 20 seconds. The vibration signal was acquired for two different shaft rotational speeds of 17 Hz and 25 Hz. Both these rotational speeds involved data from a balanced shaft (class 0) and unbalanced shaft (class 1), wherein shaft unbalance is a common fault in industrial machines. Thus, there are 2 data sets in total, one for each rotational speed. Initial 80,000 data points from each data set are used for the analysis, by creating 50 windows of 1600 data points each. A train-test split of 70%-30% was used in the examples. Mean accuracy from 100 experimental runs of training and testing the models on the two datasets is used as the metric to determine the classification accuracy and model performance.

In an industrial deployment scenario, the machine that is to be monitored can be assessed. For example, the machine may be a compressor in a continuous manufacturing industry although the machine is not limited to a compressor and may be any other suitable machine in a continuous manufacturing industry. Then, the operating speeds and common faults can be considered for that machine. Based on this information the sampling frequencies can be determined, as faults occur as periodic recurrences in time, which are captured as ‘fault signature frequencies.’ For a compressor, some common faults are shaft unbalance, misalignment, resonance which occur at 60, 120, and system resonance frequency in Hertz (Hz) respectively. To account for higher order harmonics of these fundamental frequencies, the sampling frequencies can be maintained higher in the order of ˜1-10 KHz. After determining a sampling rate, the amount of undersampling that can be done depending on the sparsity level of the signal can be theoretically and empirically determined. The sparsity level of the signal can be evaluated from transforms (e.g., the Fourier Transform), where most of the co-efficients are zero or insignificant in amplitude if there is periodicity in the signal; which is the means of identifying ‘fault signature frequencies.’

### 5. Experiments & Analysis

In this section, three use-cases of time signal recovery per the CS framework are presented. The first one is acoustic calibration. A sound calibration file obtained from a GRAS handheld calibrator was used in this work. The calibrator produces an acoustic pressure of 10 Pa-rms at about 1000 Hz.

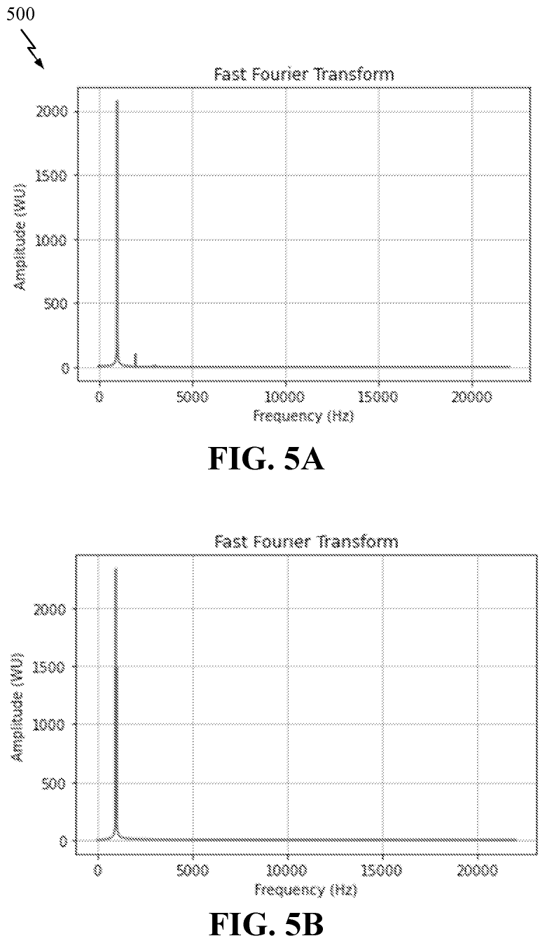

FIG. 5 shows the original and CS based recovered FFT. 10% random Gaussian samples were taken from a 10,000 data point window of the raw data, and CoSaMP's sparsity level was kept at 5. FIG. 5A shows original FFT, while FIG. 5B shows CS recovered FFT (10% samples, s=5). Both the original FFT and the CS-recovered FFT capture the acoustic calibration signal. This exercise corresponds to the simplest real-world use case of reconstructing a monotone acoustic signal using CS.

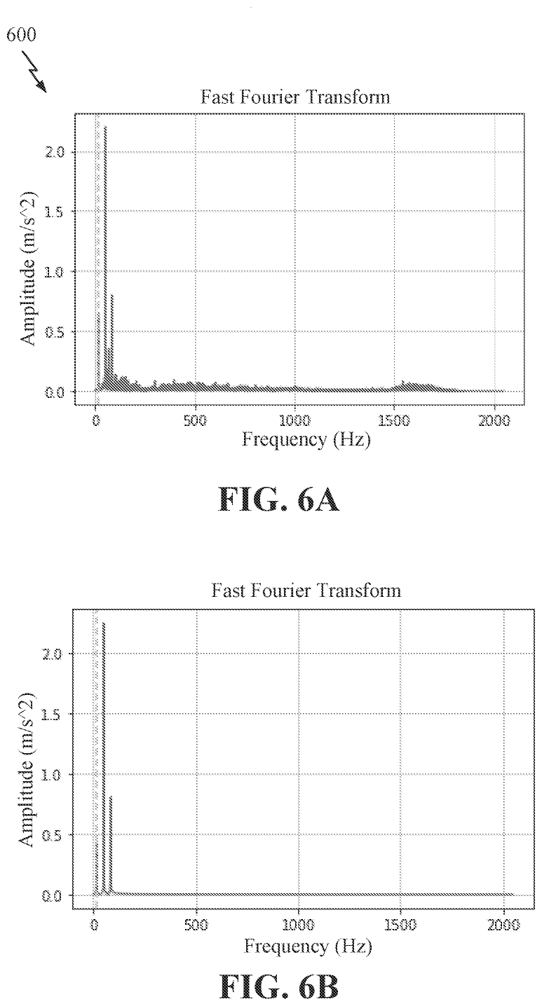

In other examples, SpectraQuest's Machinery Fault Simulator (MFS) was used for creating a shaft unbalance by adding a weight of 11 grams in a slotted disc. A commercial piezoelectric accelerometer sampling at 4096 Hz was used for experimentation. The MFS was operated at different speeds and the vibration spectrum was monitored. In this example, results are reported from a shaft speed of 17 Hz. FIG. 6 shows the original and CS based recovered FFT. FIG. 6A shows original FFT, while FIG. 6B shows CS recovered FFT (10% samples, s=5). 10% random Gaussian samples were taken from a 10,000 data point window of the raw data, and CoSaMP's sparsity level was kept at 10.

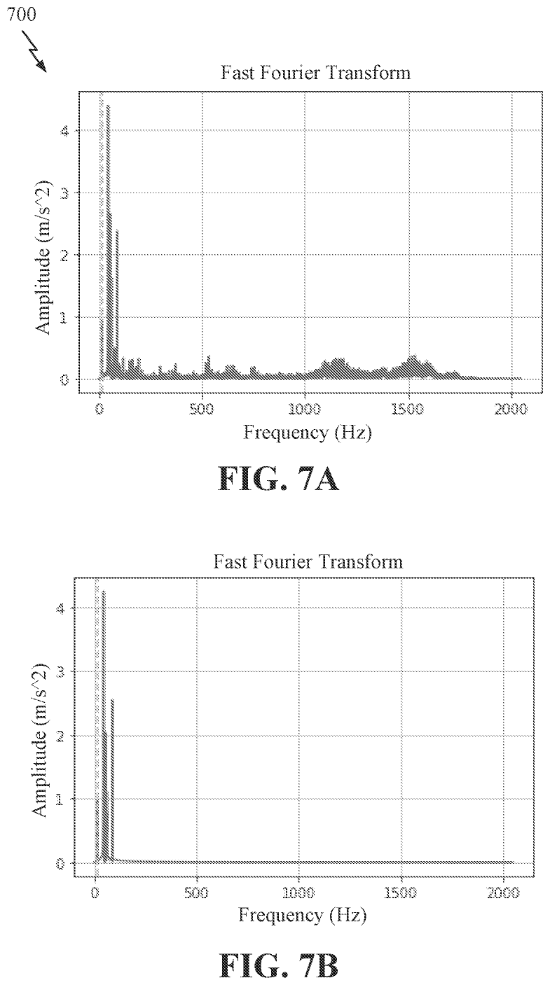

In further examples, a universal joint, a common power transmission element, was used for studying its vibration characteristics. A commercial piezoelectric accelerometer sampling at 4096 Hz was used for experimentation. The universal joint was operated at different speeds and the vibration spectrum was monitored. In this example, results were reported from a shaft speed of 15 Hz. FIG. 7 shows the original and CS based recovered FFT. 10% random Gaussian samples were taken from a 10,000 data point window of the raw data, and CoSaMP's sparsity level was kept at 10. FIG. 7A shows original FFT, while FIG. 7B shows CS recovered FFT (10% samples, s=5). The CS-recovered FFT captures the dominant frequencies present in the vibration signal. In this case, the dominant frequencies indicate the operating frequency of the universal joint, and its 3rd harmonic corresponding to the resonant frequency of the setup. Above, 3 use-cases of reconstructing a time signal using compressed sensing are presented. In manufacturing, there are a lot of opportunities to leverage the CS framework. This has implications, both from an analysis and engineering point of view. Table 2. summarizes the information extracted, data volumes, & engineering advantages, for the three time-signal use-cases considered in these examples.

TABLE 2
Summary of information extracted, data volumes, & engineering advantages.

| | Use-cases | | | | | | | | | | | |
|---|---|---|---|---|---|---|---|---|---|---|---|---|
| Evaluation | | | | | | | | | Machinery fault | | | |
| criterion | Acoustic calibration | | | | Universal joint | | | | simulator | | | |
| DAQ & analysis | FDC | TDF | TC | RDC | FDC | TDF | TC | RDC | FDC | TDF | TC | RDC |
| technique | | | | | | | | | | | | |

| | | |
|---|---|---|
| Objective | Reconstruction | Reconstruction (inference), historical analysis |

Information extraction

| | | | | | | | | | | | | |
|---|---|---|---|---|---|---|---|---|---|---|---|---|
| Useful in | Yes | No | Yes | Yes | Yes | No | Yes | Yes | Yes | No | Yes | Yes |
| context? | | | | | | | | | | | | |

| | | |
|---|---|---|
| Improvement | No | Yes, for inference (anomaly detection) |
| needed in CS? | | |

Data volume

| Sampling | 44100 | | | | 4096 | | | | 4096 | | | |
|---|---|---|---|---|---|---|---|---|---|---|---|---|
| frequency (Hz) | | | | | | | | | | | | |
| Window data size | 10000 | 10 | 5000 | 1000 | 10000 | 10 | 5000 | 1000 | 10000 | 10 | 5000 | 1000 |
| % of data needed | 100 | — | 50 | 10 | 100 | — | 50 | 10 | 100 | — | 50 | 10 |

Engineering advantages (bandwidth and bandwidth costs may vary per service)

| | | | | | | | | | | | | |
|---|---|---|---|---|---|---|---|---|---|---|---|---|
| Bandwidth | 100 | — | 50 | 10% | 100 | — | 50 | 10% | 100 | — | 50 | 10% |
| needed (%) | | | | | | | | | | | | |
| Storage needed | | | | | | | | | | | | |
| (%) | | | | | | | | | | | | |
| Costs | | | | | | | | | | | | |
| (Transmission, | | | | | | | | | | | | |
| storage) (%) | | | | | | | | | | | | |

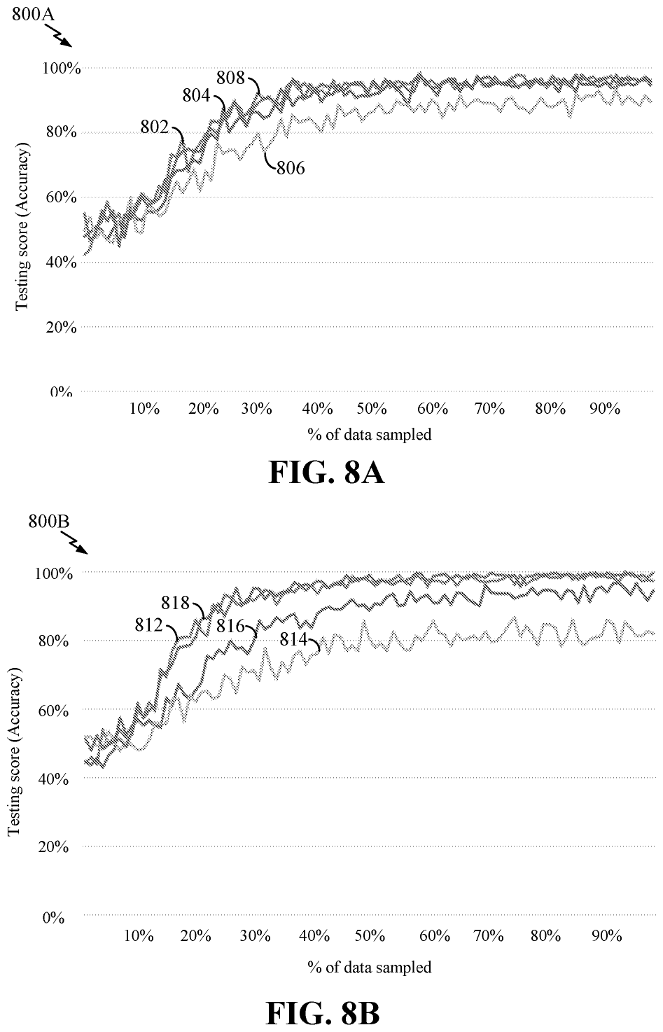

FIG. 8A is an exemplary graph showing a variation of test score of machine learning algorithms with sampling (10 averages, 25 Hz), and FIG. 8B is an exemplary graph showing a variation of test score of machine learning algorithms with sampling (10 averages, 17 Hz) according to some embodiments. FIGS. 8A and 8B show accuracy levels of different machine learning algorithms with different levels of undersampling for two experimental conditions. For example, 802 in FIG. 8A and 812 in FIG. 8B indicate a logistic regression machine learning model (max_iter=5000, penalty=‘none’); 804 in FIG. 8A and 814 in FIG. 8B indicate a MLP classifier machine learning model (hidden_layer_sizes=(800,400,200,50), max_iter=10000); 806 in FIG. 8A and 816 in FIG. 8B indicate a random forest classifier machine learning model (n_estimator=5); 808 in FIG. 8A and 818 in FIG. 8B indicate a SVC learning model (kernel='linear'). As shown in FIGS. 8A and 8B, the accuracy level using the logistic regression and SVC machine learning models is more than 80% with 20% of data sampled and about 90% with 30% of data sampled.

### Example Process

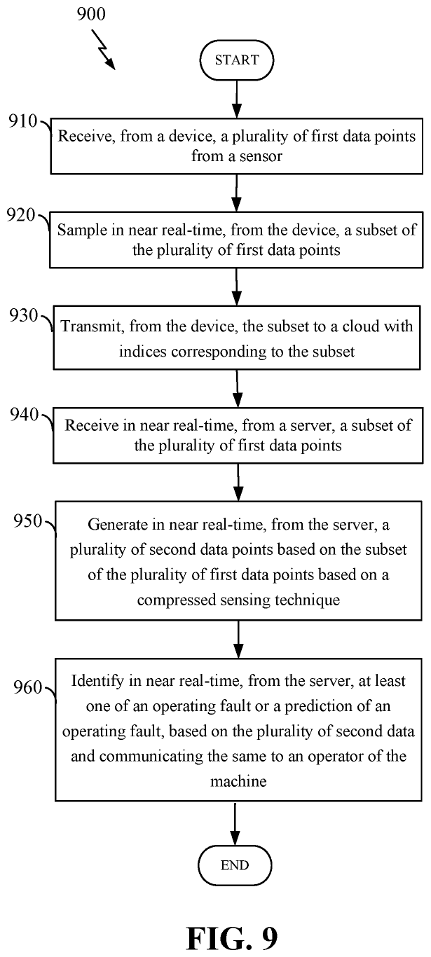

FIG. 9 is a flow chart illustrating an exemplary process for machine monitoring in accordance with some aspects of the present disclosure. As described below, a particular implementation may omit some or all illustrated features and may not require some illustrated features to implement all embodiments. In some examples, any suitable apparatus or means for carrying out the functions or algorithm described below may carry out the process 900.

In block 910, a system may receive first data from a local sensor connected to a machine. In some implementation, the local sensor can be disposed on or near a machine, so as to directly sense operating conditions of the machine to generate the first data points; other embodiments may rely on indirect sensing or interpreting a given parameter based on sensing other parameters (e.g., sensing temperature and sound may indicate grinding or friction or may indicate quality of lubricant). In some examples, the data may include raw or high-fidelity incoming sensor data (in-situ process) and previously stored sensor data (ex-situ process); in other embodiments. The first data may include vibration, sound, acoustic, temperature, pressure, weight, force, flow, pitch, angle, optical, infrared, depth, magnetic, scatter, emissions, waste, fluorescence, among others, to capture ‘signatures’ of underlying machinery. These signatures carry information about a machine's operating condition. Different faults like shaft unbalance, misalignment, looseness show up in the multiple first data points.

In block 920, the system may sample in real-time a subset of the first data points. In other words, a device having suitable processing power may receive data directly from a sensor (whether in real time, periodic, etc.), and sample that data. The subset of first data points may represent an undersampling of the first data points of the sensor. In some examples, the subset of the first data stored by the system may comprise data that was Gaussian-randomly sampled from the incoming sensor data and data randomly sampled from previous data. Thus, the device may sample a set percentage or statistical measure of the first data points. The subset of the plurality of data points may be equal to or less than 30% of the plurality of data points. In some examples, only 10% of the multiple first data points using the Gaussian random sampling may be sufficient for accurate signal reconstruction in machine monitoring. However, it should be appreciated that the sampling is not limited to Gaussian random sampling. It may be other suitable sampling schemes, such as every other/third/fourth/fifth/etc. data point, only data points that deviate from the previous data point by a significant margin, weighted sampling by amplitude or other signal characteristic, or other suitable schemes. In some examples, the device may also generate indices corresponding to the random data points of the subset. In other examples, the device may use a fixed seed that the server knows. That is, the device and the server know indices corresponding to random points of the subset before the device transmits the subset to the server. That is, the device does not need to send indices to the server due to the fixed seed. Here, real-time indicates less than a millisecond or a half-second.

In block 930, the system may transmit the subset of multiple first data points from the processing device near/connected to the sensor to a remote device, such as a cloud device or other more powerful processing resource. In some examples, the processing device near the sensor may also transmit indices corresponding to random points of the subset. However, as elaborated above, when the device uses a fixed seed, the device does not need to transmit the indices. In block 940, a server may receive in real-time the subset of multiple first data points. Here, the device only transmits the randomly sampled data (i.e., the subset of multiple first data points), and does not transmit the full sensor data (i.e., the multiple first data points). Thus, this substantially reduces the amount of data sent to the server. In some embodiments, however, the processing device local to the sensor may periodically transmit a full window of data (e.g., a full 30 seconds, or a full minute, or a full hour, or a full production run/cycle, depending on the machine and process) to allow for the remote device to check accuracy of the signal reconstruction and ensure that the desired attributes to be monitored are being monitored accurately under the CS scheme.

In block 950, the server that is receiving the data from the local processing device may generate in real-time multiple second data points based on the subset of the plurality of first data points based on a compressed sensing technique. This can take the form of recreating a transformation of the original signal (e.g., a Fourier transform of the original signal) or recreating the original signal in its original domain directly from the undersampled data. In any case, the multiple second data points are less than the original first data points. That is, recovering the full signal (i.e., the multiple first data points) using compressed sensing is not required nor necessary in all cases because accuracy of the types of monitoring techniques utilized for machine monitoring do not sharply improve beyond a certain amount of undersampling. Thus, there is no need to collect all the incoming sensor data. For problems pertaining to machine monitoring like classification and anomaly detection, machine learning algorithms can be directly used on the compressed representation which is learned from undersampled sensor data (i.e., the subset of the multiple first data points). In some examples, the compressed sensing technique includes a compressive sampling matching pursuit (CoSaMP) algorithm.

In block 960, the server may identify in real-time at least one of an operating fault or a prediction of an operating fault, based on the plurality of second data and communicate the same to an operator of the machine. In some examples, the operating fault includes at least one or more of: shaft unbalance, misalignment, or resonance. In some examples, the identifying the operating fault is performed further based on a machine learning model.

In some examples, for solving problems pertaining to predictive machine monitoring like classification and anomaly detection, low-dimensional representations learned from undersampled data can be used. Thus, the server does not need to use high-dimensional sensor measurements (i.e., the multiple first data points). In some examples, machine learning algorithms can be used directly on the low-dimensional representations, which are learnt from undersampled sensor data (i.e., the subset of the multiple first data points). In some instances, this low-dimensional embedding for the low-dimensional representations is the Fast Fourier Transform (FFT). The primary property of low-dimensional embedding (FFT) is to preserve the information while reducing the data dimensionality (memory requirements). Other parametric and non-parametric low-dimensional embeddings can be learned using undersampled data. Because the FFT encodes the full signal in a lower dimension, it can also be used for tasks that require low-dimensional data, such as classification and anomaly detection. The physics of the original high-dimensional signal is preserved by the low-dimensional embedding (FFT), which has been learned from undersampled data.

In further examples, the server may train the machine learning model using low-dimensional representation training data. In some instances, the server may generate multiple low-dimensional representations corresponding to the multiple second data points. Then, the server may identify the at least one of an operating fault or a prediction of an operating fault based on the multiple low-dimensional representations and the trained machine learning model. In further instances, the server may further train the machine learning model using the multiple low-dimensional representations. Further, the server may communicate the same to an operator of the machine for the operating fault or a prediction of the operating fault.

### Hardware Configuration Example

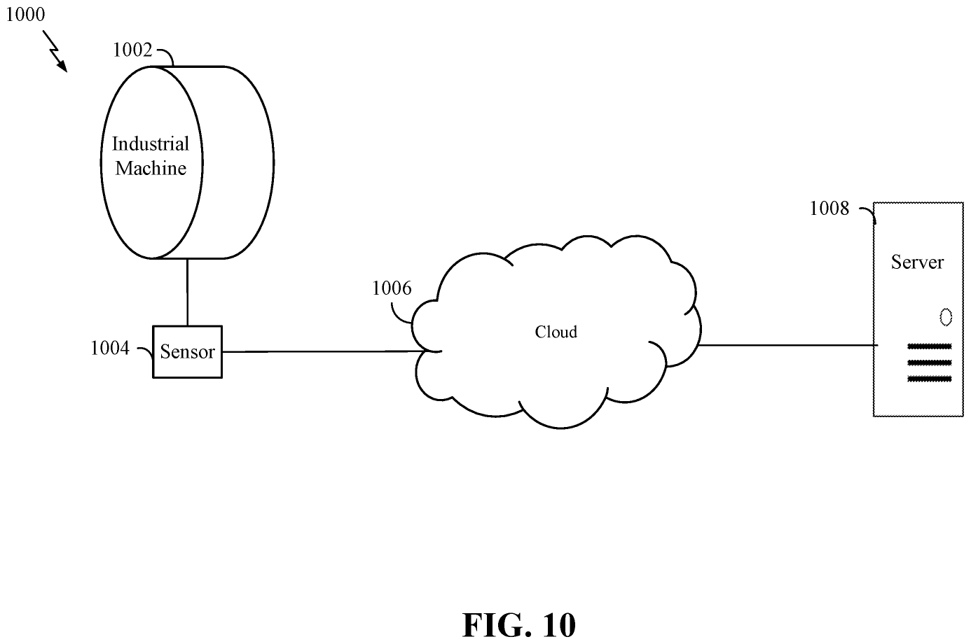

FIG. 10 is a conceptual diagram showing the interrelationship of multiple exemplary components which acquire, sample, transmit, and process data according to the techniques described above.

For example, a device 1004 may monitor an industrial machine (e.g., including a shaft, a slotted disk, a universal joint, etc.). The device 1004 may detect a sensor signal from the industrial machine. The device 1004 signal may include vibration, sound, acoustic emission to capture the machine's operating condition including faults (e.g., shaft unbalance, misalignment, looseness etc of an industrial machine 1002.). The sensor signal is a raw time signal, a full signal, or a high dimensional signal. The device 1004 may include a processor and a memory to undersample the full signal having full data points. For example, the device 1004 may perform Gaussian randomly sampling for the full signal. Thus, the device 1004 may sample a set percentage (e.g., 10%, 30%) of the full signal.

The device 1004 may transmit the undersampled signal or a subset of the full signal to the server 1008 via the cloud 1006 or without the cloud 1006. Thus, the device 1004 reduces the amount of data to be transmitted to the server 1008 without providing the full signal to the server 1008. Then, the server 1008 may recover the full signal based on compressed sensing technique. However, the recovered signal is still a reduced signal of the full signal that the device 1004 detects as a sensor signal. For example, the recovered signal has less data points than the data points in the full signal. In some examples, the compressed sensing technique may include a compressive sampling matching pursuit (CoSaMP) algorithm. In further examples, the server 1008 may further reduce the amount of the signal using the low-dimensional embedding (e.g., Fast Fourier Transform). The server 1008 may use machine learning based on the low-dimensional representations from the low-dimensional embedding. Thus, the machine learning may be directly learnt from the low-dimensional representations or undersampled data. Based on the machine learning, the server 1008 may determine whether the industrial machine 1002 may have a fault.

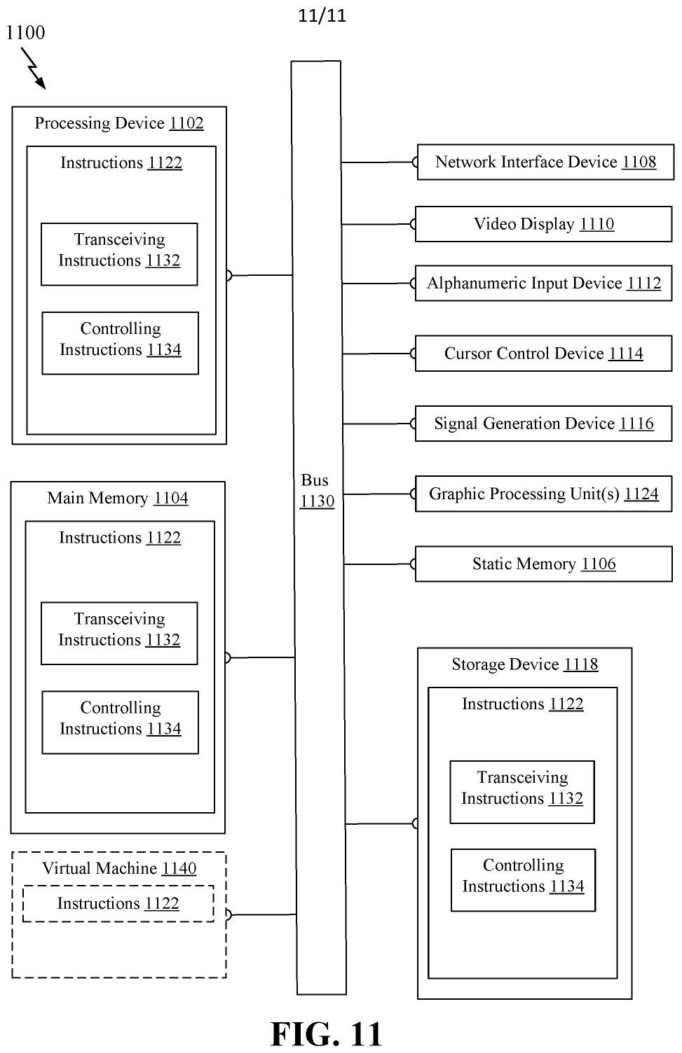

FIG. 11 is a block diagram conceptually illustrating an example apparatus (a device or a server) of a computer system 1100 within which a set of instructions, for causing the device or server to perform any one or more of the methods disclosed herein, may be executed. In alternative implementations, the apparatus may be connected (such as networked) to other apparatus in a LAN, an intranet, an extranet, and/or the Internet.

The apparatus may operate in the capacity of a server or a client machine in a client-server network environment, as a peer machine in a peer-to-peer (or distributed) network environment, or as a server or a client machine in a cloud computing infrastructure or environment. The apparatus may be a server computer, a personal computer (PC), a tablet, an IoT device, a cellular telephone, a web appliance, a server, a network router, a switch or bridge, or any apparatus capable of executing a set of instructions (sequential or otherwise) that specify actions to be taken by that apparatus. Further, while a single apparatus is illustrated, the term “apparatus” shall also be taken to include any collection of apparatuses that individually or jointly execute a set (or multiple sets) of instructions to perform any one or more of the methods discussed herein.

The example computer system 1100 includes a processing device 1102, a main memory 1104 (such as read-only memory (ROM), flash memory, dynamic random access memory (DRAM) such as synchronous DRAM (SDRAM) or DRAM, etc.), a static memory 1106 (such as flash memory, static random access memory (SRAM), etc.), and a data storage device 1118, which communicate with each other via a bus 1130.

Processing device 1102 represents an electronic processor, one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 is configured to execute instructions 1122 for performing the operations and steps discussed herein.

The computer system 1100 may further include a network interface device 1108 for connecting to the LAN, intranet, internet, and/or the extranet. The computer system 1100 also may include a video display unit 1110 (such as a liquid crystal display (LCD) or a cathode ray tube (CRT)), an alphanumeric input device 1112 (such as a keyboard), a cursor control device 1114 (such as a mouse), a signal generation device 1116 (such as a speaker), and a graphic processing unit 1124 (such as a graphics card).

The data storage device 1118 may be a machine-readable storage medium 1128 (also known as a computer-readable medium) on which is stored one or more sets of instructions or software 1122 embodying any one or more of the methods or functions described herein. The instructions 1122 may also reside, completely or at least partially, within the main memory 1104 and/or within the processing device 1102 during execution thereof by the computer system 1100, the main memory 1104 and the processing device 1102 also constituting machine-readable storage media.

In one implementation, the instructions 1122 include transceiving instructions for receiving, from a device, a plurality of first data points from a local sensor connected to a machine; transmitting, from the device, the subset to a cloud with indices corresponding to the subset; receiving in real-time, from a server, the subset of the plurality of first data points; and/or communicating to an operator of the machine at blocks 910, 930, and/or 940 of FIG. 9. The instructions 1122 may further include controlling instructions 1134 for sampling in real-time, from the device, a subset of the plurality of first data points; generating in real-time, from the server, a plurality of second data points based on the subset of the plurality of first data points based on a compressed sensing technique; identifying in real-time, from the server, at least one of an operating fault or a prediction of an operating fault, based on the plurality of second data; and/or generating a plurality of low-dimensional representations corresponding to the plurality of second data points at blocks 920, 950, and/or 960 of FIG. 9. While the machine-readable storage medium 1118 is shown in an example implementation to be a single medium, the term “machine-readable storage medium” should be taken to include a single medium or multiple media (such as a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media. The term “machine-readable storage medium” shall accordingly exclude transitory storage mediums such as signals unless otherwise specified by identifying the machine-readable storage medium as a transitory storage medium or transitory machine-readable storage medium.

In another implementation, a virtual machine 1140 may include a module for executing instructions such as transceiving instructions 1132, and/or controlling instructions 1134. In computing, a virtual machine (VM) is an emulation of a computer system. Virtual machines are based on computer architectures and provide functionality of a physical computer. Their implementations may involve specialized hardware, software, or a combination of hardware and software.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “modifying” or “providing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices. The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (such as a computer). For example, a machine-readable (such as computer-readable) medium includes a machine (such as a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

### Further Examples Having a Variety of Features

Example 1: A method, apparatus, and non-transitory computer-readable medium operabale at a server for industrial machine monitoring, comprising: obtaining, by an electronic processor, a subset of a plurality of first data points from a local sensor connected to a machine, the local sensor configured to directly sense operating conditions of the machine to generate the plurality of first data points, the subset of the plurality of first data points representing an undersampling of output of the local sensor; generating, by the electronic processor, a plurality of second data points based on the subset of the plurality of first data points based on a compressed sensing technique, wherein the plurality of second data points is less than the plurality of first data points; and identifying, by the electronic processor, at least one of an operating fault or a prediction of an operating fault, based on the plurality of second data and communicating at least one of the operating fault or the prediction of an operating fault to an operator of the machine.

Example 2: The method, apparatus, and non-transitory computer-readable medium of Example 1, wherein the plurality of first data points comprises incoming sensor data and previously stored data.

Example 3: The method, apparatus, and non-transitory computer-readable medium of any of Examples 1 to 2, wherein the subset of the plurality of first data points comprises first data Gaussian randomly sampling the incoming sensor data and second data randomly sampling the previous stored data.

Example 4: The method, apparatus, and non-transitory computer-readable medium of any of Examples 1 to 3, wherein the subset of the plurality of first data points is equal to or less than 30% of the plurality of first data points.

Example 5: The method, apparatus, and non-transitory computer-readable medium of any of Examples 1 to 4, the subset of the plurality of first data points is acquired by randomly sampling the plurality of first data points with a fixed seed.

Example 6: The method, apparatus, and non-transitory computer-readable medium of any of Examples 1 to 5, wherein the randomly sampling of the plurality of first data points uses a Gaussian random sampling scheme.

Example 7: The method, apparatus, and non-transitory computer-readable medium of any of Examples 1 to 6, wherein the compressed sensing technique comprises a compressive sampling matching pursuit (CoSaMP) algorithm.

Example 8: The method, apparatus, and non-transitory computer-readable medium of any of Examples 1 to 7, wherein the identifying of the operating fault is performed further based on a machine learning model.

Example 9: The method, apparatus, and non-transitory computer-readable medium of any of Examples 1 to 8, wherein the operating fault includes at least one or more of: shaft unbalance, misalignment, or resonance.

Example 10: The method, apparatus, and non-transitory computer-readable medium of any of Examples 1 to 9, the identifying of the operating fault is performed based on classification or anomaly detection.

Example 11: The method, apparatus, and non-transitory computer-readable medium of any of Examples 1 to 10, further comprising: generating, by the electronic processor, a plurality of low-dimensional representations corresponding to the plurality of second data points, wherein the at least one of an operating fault or a prediction of an operating fault is identified based on the plurality of low-dimensional representations.

Example 12: The method, apparatus, and non-transitory computer-readable medium of any of Examples 1 to 11, wherein the identifying the operating fault is performed further based on a machine learning model, wherein the method was trained with a plurality of low-dimensional representation training data.

Example 13: A method and a system including a device and a server for industrial machine monitoring, comprising: receiving, from an electronic processor of a device, a plurality of first data points from a local sensor connected to a machine, the local sensor configured to directly sense operating conditions of the machine to generate the plurality of first data points; sampling in real-time, from the electronic processor of the device, a subset of the plurality of first data points, the subset of the plurality of first data points representing an undersampling of the plurality of first data points of the local sensor; transmitting, from the electronic processor of the device, the subset to a cloud with indices corresponding to the subset; receiving in real-time, from an electronic processor of a server, the subset of the plurality of first data points; generating in real-time, from the electronic processor of the server, a plurality of second data points based on the subset of the plurality of first data points based on a compressed sensing technique, wherein the plurality of second data points is less than the plurality of first data points; and identifying in real-time, from the electronic processor of the server, at least one of an operating fault or a prediction of an operating fault, based on the plurality of second data and communicating at least one of the operating fault or the prediction of the operating fault to an operator of the machine.

Example 14: The method and a system of Example 13, wherein the plurality of first data points comprises incoming sensor data and previously stored data.

Example 15: The method and a system of Example 13 or 14, wherein the subset of the plurality of first data points comprises first data Gaussian randomly sampling the incoming sensor data and second data randomly sampling the previous stored data.

Example 16: The method and a system of any of Examples 13 to 15, wherein the subset of the plurality of first data points is equal to or less than 30% of the plurality of first data points.

Example 17: The method and a system of any of Examples 13 to 16, wherein the subset of the plurality of first data points is acquired by randomly sampling the plurality of first data points with a fixed seed.

Example 18: The method and a system of any of Examples 13 to 17, wherein the sampling of the plurality of first data points uses a Gaussian random sampling scheme.

Example 19: The method and a system of any of Examples 13 to 18, wherein the compressed sensing technique comprises a compressive sampling matching pursuit (CoSaMP) algorithm.

Example 20: The method and a system of any of Examples 13 to 19, wherein the identifying of the operating fault is performed further based on a machine learning model.

Example 21: The method and a system of any of Examples 13 to 20, wherein the operating fault includes at least one or more of: shaft unbalance, misalignment, or resonance.

Example 22: The method and a system of any of Examples 13 to 21, wherein the identifying of the operating fault is performed based on classification or anomaly detection.

Example 23: The method and a system of any of Examples 13 to 22, further comprising: generating from the electronic processor of the server, a plurality of low-dimensional representations corresponding to the plurality of second data points, wherein the at least one of an operating fault or a prediction of an operating fault is identified based on the plurality of low-dimensional representations.

Example 24: The method and a system of any of Examples 13 to 23, wherein the identifying the operating fault is performed further based on a machine learning model, and wherein the machine learning model was trained by a plurality of low-dimensional representation training data.

What is claimed is:

1. A method operable at a server for industrial machine monitoring, comprising:
obtaining, by an electronic processor, a subset of a plurality of first data points from a local sensor connected to a machine, the local sensor configured to directly sense operating conditions of the machine to generate the plurality of first data points, the subset of the plurality of first data points representing an undersampling of output of the local sensor;
generating, by the electronic processor, a plurality of second data points based on the subset of the plurality of first data points based on a compressed sensing technique, wherein the plurality of second data points is less than the plurality of first data points; and
identifying, by the electronic processor, at least one of an operating fault or a prediction of an operating fault, based on the plurality of second data and communicating at least one of the operating fault or the prediction of an operating fault to an operator of the machine.

2. The method of claim 1, wherein the plurality of first data points comprises incoming sensor data and previously stored data.

3. The method of claim 2, wherein the subset of the plurality of first data points comprises first data Gaussian randomly sampling the incoming sensor data and second data randomly sampling the previous stored data.

4. The method of claim 1, wherein the subset of the plurality of first data points is equal to or less than 30% of the plurality of first data points.

5. The method of claim 1, wherein the subset of the plurality of first data points is acquired by randomly sampling the plurality of first data points with a fixed seed.

6. The method of claim 5, wherein the randomly sampling of the plurality of first data points uses a Gaussian random sampling scheme.

7. The method of claim 1, wherein the compressed sensing technique comprises a compressive sampling matching pursuit (CoSaMP) algorithm.

8. The method of claim 1, wherein the identifying of the operating fault is performed further based on a machine learning model.

9. The method of claim 1, wherein the operating fault includes at least one or more of: shaft unbalance, misalignment, or resonance.

10. The method of claim 1, wherein the identifying of the operating fault is performed based on classification or anomaly detection.

11. The method of claim 1, further comprising:
generating, by the electronic processor, a plurality of low-dimensional representations corresponding to the plurality of second data points,
wherein the at least one of an operating fault or a prediction of an operating fault is identified based on the plurality of low-dimensional representations.

12. The method of claim 11, wherein the identifying the operating fault is performed further based on a machine learning model, and
wherein the method was trained with a plurality of low-dimensional representation training data.

13. A method for machine monitoring, comprising:
receiving, from an electronic processor of a device, a plurality of first data points from a local sensor connected to a machine, the local sensor configured to directly sense operating conditions of the machine to generate the plurality of first data points;
sampling in real-time, from the electronic processor of the device, a subset of the plurality of first data points, the subset of the plurality of first data points representing an undersampling of the plurality of first data points of the local sensor;
transmitting, from the electronic processor of the device, the subset to a cloud with indices corresponding to the subset;
receiving in real-time, from an electronic processor of a server, the subset of the plurality of first data points;
generating in real-time, from the electronic processor of the server, a plurality of second data points based on the subset of the plurality of first data points based on a compressed sensing technique, wherein the plurality of second data points is less than the plurality of first data points; and
identifying in real-time, from the electronic processor of the server, at least one of an operating fault or a prediction of an operating fault, based on the plurality of second data and communicating at least one of the operating fault or the prediction of the operating fault to an operator of the machine.

14. The method of claim 13, wherein the plurality of first data points comprises incoming sensor data and previously stored data.

15. The method of claim 14, wherein the subset of the plurality of first data points comprises first data Gaussian randomly sampling the incoming sensor data and second data randomly sampling the previous stored data.

16. The method of claim 13, wherein the subset of the plurality of first data points is equal to or less than 30% of the plurality of first data points.

17. The method of claim 13, wherein the subset of the plurality of first data points is acquired by randomly sampling the plurality of first data points with a fixed seed.

18. The method of claim 17, wherein the sampling of the plurality of first data points uses a Gaussian random sampling scheme.

19. The method of claim 13, wherein the compressed sensing technique comprises a compressive sampling matching pursuit (CoSaMP) algorithm.

20. The method of claim 13, wherein the identifying of the operating fault is performed further based on a machine learning model.

21. The method of claim 13, wherein the operating fault includes at least one or more of: shaft unbalance, misalignment, or resonance.

22. The method of claim 13, wherein the identifying of the operating fault is performed based on classification or anomaly detection.

23. The method of claim 13, further comprising:
generating from the electronic processor of the server, a plurality of low-dimensional representations corresponding to the plurality of second data points, and
wherein the at least one of an operating fault or a prediction of an operating fault is identified based on the plurality of low-dimensional representations.

24. The method of claim 23, wherein the identifying the operating fault is performed further based on a machine learning model,
wherein the machine learning model was trained by a plurality of low-dimensional representation training data.
